(19) United States
(12) Patent Application Publication
(10) Pub. No.: US 2017/0050348 A1
(43) Pub. Date: Feb. 23, 2017

(54) METHOD FOR PRODUCING POLYIMIDE TUBULAR MEMBER

(71) Applicant: FUJI XEROX CO., LTD., Tokyo (JP)

(72) Inventor: Hiroaki TANAKA, Kanagawa (JP)

(73) Assignee: FUJI XEROX CO., LTD., Tokyo (JP)

(21) Appl. No.: 15/148,045

(22) Filed: May 6, 2016

(30) Foreign Application Priority Data
Aug. 18, 2015 (JP) 2015-160972

(51) Int. Cl. B29C 41/00; B29C 41/46; B29C 41/36; C09D 179/08; B29C 41/02

(52) U.S. Cl. CPC B29C 41/003; C09D 179/08; B29C 41/02; B29C 41/36; B29C 41/46; B29C 41/40

(57) ABSTRACT

A method for producing a polyimide tubular member includes preparing a polyimide precursor solution, heating the polyimide precursor solution, coating a core with the heated polyimide precursor solution to form a coating film, drying the coating film, and baking the dried coating film to perform imidization.

### CROSS-REFERENCE TO RELATED APPLICATIONS

This application is based on and claims priority under 35 USC 119 from Japanese Patent Application No. 2015-160972 filed Aug. 18, 2015.

### BACKGROUND

(i) Technical Field

The present invention relates to a method for producing a polyimide tubular member.

(ii) Related Art

An electrophotographic image forming apparatus forms an image through the following process: First, charges are formed on a surface of an image-carrying member, which is an electrophotographic photosensitive member containing an inorganic or organic material. An electrostatic latent image is then formed on the surface by using a laser beam modified by an image signal, and the electrostatic latent image is developed with a charged toner so as to form a visible toner image. The toner image is electrostatically transferred onto a transfer-receiving material such as recording paper either directly or via a belt (intermediate transfer belt) serving as an intermediate transfer body.

### SUMMARY

According to an aspect of the invention, a method for producing a polyimide tubular member includes preparing a polyimide precursor solution; heating the polyimide precursor solution; coating a core with the heated polyimide precursor solution to form a coating film; drying the coating film; and baking the dried coating film to perform imidization.

### BRIEF DESCRIPTION OF THE DRAWINGS

Exemplary embodiments of the present invention will be described in detail based on the following figures, wherein:

FIG. 1 is a schematic view illustrating an example of a coating step in an exemplary embodiment; and

FIG. 2 is a schematic view showing a part of a coater used in the coating step shown in FIG. 1 in close-up.

### DETAILED DESCRIPTION

Exemplary embodiments of the present invention will now be described with reference to drawings. In the drawings, parts and components not relevant to the description are omitted to promote understanding of the exemplary embodiments. Parts and components having the same or similar function are denoted by the same reference symbols throughout the drawings and the descriptions therefor may be omitted to avoid redundancy.

A method for producing a polyimide tubular member according to an exemplary embodiment includes a solution preparation step of preparing a polyimide precursor solution; a heating step of heating the polyimide precursor solution; a coating step of coating a core with the heated polyimide precursor solution so as to form a coating film; a drying step of drying the coating film; and a baking step of baking the dried coating film to conduct imidization.

According to the method for producing a polyimide tubular member of this exemplary embodiment, product defects caused by film shrinking during the baking step are decreased. The reason for this is presumed to be as follows.

In producing an endless belt containing a polyimide resin (polyimide tubular member), a polyimide precursor solution is applied to an outer peripheral surface of a cylindrical or columnar core by, for example, a spiral coating method (flow coating method) to form a coating film. The coating film is dried by being heated, and baked at a higher temperature to promote and make complete imidization reaction. As a result, a tubular member containing a polyimide resin (polyimide tubular member) is obtained. After baking, the tubular member is separated from the core, and two end portions (non-product portions) of the tubular member are cut so as to adjust the belt width to a desired width. As a result, a target endless belt is obtained.

According to this process of producing a polyimide tubular member, the film shrinks during the baking step. If the shrinkage is large, undulations on the outer peripheral surface become extensive, resulting in defective appearance and possibly separation from the core. A product portion that has separated from the core during the baking step can no longer be used as a product. The cause of separation of the film from the core during the baking step is probably that when the polyimide precursor contained in the dried coating film is being imidized, dehydration and shrinking caused by ring closing decrease the volume of the film and increase the shrinking width in the axial direction.

In contrast, according to a method for producing a polyimide tubular member of this exemplary embodiment, the polyimide precursor solution is heated prior to coating the core so as to promote imidization to a particular extent in the polyimide precursor solution. This presumably decreases the amount of the precursor imidized in the baking step, decreases the amount of water removed and shrinkage of the film, and suppresses separation from the core.

The individual steps of the method for producing a polyimide tubular member according to this exemplary embodiment are described below in detail.

### Solution Preparation Step

First, in the solution preparation step, a polyimide precursor solution is prepared.

The polyimide precursor solution (polyamic acid solution) is obtained by causing tetracarboxylic dianhydride to react with a diamine component in a solvent.

The polyimide precursor may be of any type and may be an aromatic polyimide precursor obtained by causing an aromatic tetracarboxylic dianhydride to react with an aromatic diamine component from the viewpoint of strength.

Representative examples of the aromatic tetracarboxylic dianhydride include pyromellitic dianhydride, 3,3′,4,4′-biphenyltetracarboxylic dianhydride, 3,3′,4,4′-benzophenonetetracarboxylic dianhydride, 2,3,4,4′-biphenyltetracarboxylic dianhydride, 2,3,6,7-naphthalenetetracarboxylic dianhydride, 1,2,5,6-naphthalenetetracarboxylic dianhydride, 2,2-bis(3,4-dicarboxyphenyl) ether dianhydride, esters of these tetracarboxylic acids, and any mixture of these tetracarboxylic acids.

Examples of the aromatic diamine component include p-phenylenediamine, m-phenylenediamine, 4,4′-diaminodiphenyl ether, 4,4′-diaminophenylmethane, benzidine, 3,3′-dimethoxybenzidine, 4,4′-diaminodiphenylpropane, and 2,2-bis[4-(4-aminophenoxy)phenyl]propane.

In producing a polyimide tubular member having a multilayer structure constituted by a polyimide layer and a metal layer stacked on top of each other, a PI-silica hybrid material constituted by polyimide (PI) and an alkoxysilane compound bonded to PI may be used to improve adhesion between the polyimide layer and the metal layer as disclosed in Japanese Unexamined Patent Application Publication No. 2003-136632.

Examples of the solvent contained in the polyimide precursor solution include aprotic polar solvents such as N-methylpyrrolidone, N,N-dimethylacetamide, and acetamide.

The polyimide precursor solution used in this exemplary embodiment may contain a conductive agent.

Examples of the conductive agent include carbon black such as ketjen black and acetylene black; pyrolytic carbon and graphite; conductive metals and alloys such as aluminum, copper, nickel, and stainless steel; conductive metal oxides such as tin oxide, indium oxide, titanium oxide, tin oxide-antimony oxide solid solution, and tin oxide-indium oxide solid solution; and insulating materials having surfaces treated to exhibit electrical conductivity. These materials are in particulate form (powder).

Among these, carbon black may be used considering cost, productivity of coating solutions, stability of coating solutions, film strength, and environmental stability.

Conductive particles used as the conductive agent may be subjected to various types of surface treatment. Examples of the surface treatment include known surface treatment methods such as resin coating treatment and fluorine coating treatment. In particular, the fluorine coating treatment and the resin coating treatment can decrease the conductivity of the conductive agent. More conductive particles can be added to the polyimide tubular member if the conductivity of the conductive agent is decreased. In such a case, although the current that flows in one conductive path is low, the number of conductive paths can be increased. Accordingly, conductive particles subjected to surface treatment that decreases conductivity may be used in order to increase the number of conductive paths.

Specific examples of carbon black are as follows (primary particle diameter and pH are enclosed in parentheses):

“SPECIAL BLACK 350 (31 nm, 3.5)”, “SPECIAL BLACK 100 (50 nm, 3.3)”, “SPECIAL BLACK 250 (56 nm, 3.1)”, “SPECIAL BLACK 5 (20 nm, 3.0)”, “SPECIAL BLACK 4 (25 nm, 3.0)”, “SPECIAL BLACK 4A (25 nm, 3.0)”, “SPECIAL BLACK 550 (25 nm, 2.8)”, “SPECIAL BLACK 6 (17 nm, 2.5)”, “COLOUR BLACK FW200 (13 nm, 2.5)”, “COLOUR BLACK FW2 (13 nm, 2.5)”, “COLOUR BLACK FW2V (13 nm, 2.5)”, and “COLOUR BLACK FW1(13 nm, 4.5)” produced by Orion Engineered Carbons, and “MONARCH 1000”, “MONARCH 1300”, “MONARCH 1400”, “MOGUL-L”, and “REGAL 400R” produced by Cabot Corporation.

These conductive agents can be used alone or in combination.

The conductive agent content may be determined according to the volume resistivity. For example, the conductive agent content relative to 100 parts by mass of the resin is 1 or more and 50 or less parts by mass and may be 15 to 40 parts by mass.

The polyimide precursor solution used in this exemplary embodiment may further contain materials other than the polyimide precursor and the conductive agent. Examples of these materials include a plasticizer, a curing agent, a softener, an antioxidant, and a surfactant.

The solid component concentration of the polyimide precursor solution is adjusted according to the ease of coating, intended usage of the polyimide tubular member to be produced, etc. The solid component concentration of the polyimide precursor solution may be 10% by mass or more and 40% by mass or less.

In the solution preparation step, another polyimide precursor solution containing a different solvent or having a different viscosity may be added to decrease the solid component concentration, adjust viscosity, etc.

### <Heating Step>

In the heating step, the polyimide precursor solution is heated. Imidization of the polyimide precursor is carried out to a particular extent by heating the polyimide precursor solution prior to coating the core with it.

Imidization of a part of the polyimide precursor is carried out in advance by heating before coating. However, excessive imidization increases the viscosity of the polyimide precursor solution and makes it difficult to level the solution applied to the core, possibly resulting in thickness nonuniformity (undulations) of the coating film. In order to promote imidization of the polyimide precursor before coating, suppress shrinking of the film during the baking step, and suppress an increase in viscosity before coating, the temperature to which the polyimide precursor solution is heated in the heating step may be 40° C. or higher and 190° C. or lower, 50° C. or higher and 150° C. or lower, about 50° C. or higher and about 150° C. or lower, or 50° C. or higher and 80° C. or lower.

The heating time depends on the heating temperature. From the viewpoints of promoting imidization, suppressing an increase in viscosity, and increasing productivity, the heating time may be 15 to 30 minutes.

In order to suppress thickness nonuniformity (undulations) of the coating film in the coating step, the polyimide precursor solution may have a viscosity of 1 Pa·s or more and 50 Pa·s or less, for example. The viscosity of the polyimide precursor solution is a value measured with TV-20 viscometer, cone-plate type, produced by TOKI SANGYO CO., LTD., at a measurement temperature of 25° C.

Heating of the polyimide precursor solution may be conducted after or during preparation of the polyimide precursor solution. In other words, the heating step may be performed after or during preparation of the polyimide precursor solution in the solution preparation step.

The polyimide precursor solution may be heated by any method. In order to avoid excessive local imidization in the region near a heating source, the solution may be stirred during heating.

The imidization degree of the polyimide precursor solution in the heating step may be 8% or more and 16% or less.

The imidization degree is determined by an infrared absorption spectrum (IR) method as follows.

1) When a polyimide precursor is provided as a solution in an organic solvent such as N-methylpyrrolidone, the polyimide precursor is applied to a glass substrate or a fluororesin resin substrate by dip coating or spin coating so as to obtain a film (A) having a thickness of about 10 to 20 μm.
2) The film (A) is immersed in a solvent at 25±5° C. for 3 minutes. The solvent is a poor solvent for polyimide precursors such as tetrahydrofuran (THF) and has a boiling point lower than 100° C. The organic solvent is then removed and the polyimide precursor is precipitated to obtain a film (B).
3) The film (B) is vacuum-dried (−0.08 MPa) for 15 minutes at 25±5° C. The resulting film formed of the polyimide precursor is separated from the substrate to obtain a measurement sample film (C).
4) The film (C) is analyzed by a transmission method using an infrared spectrometer (FT-730 produced by Horiba Ltd.).
5) The film (C) is baked for 2 hours at a temperature equal to or higher than the glass transition temperature (Tg) of the corresponding polyimide to prepare Sample (D) used as the standard sample with an imidization degree of 100%. Sample (D) is subjected to IR measurement by the method described above.
6) The imidization degree is calculated by using formula (3) below.

Imidization degree (%)=[absorption peak intensity derived from imide ring in film (C)/absorption peak intensity derived from internal standard aromatic ring in film (C)]/[absorption peak intensity derived from imide ring in film (D)/absorption peak intensity derived from internal standard aromatic ring in film (D)]×100(%) Formula (3):

### Coating Step

In the coating step, the core is coated with the heated polyimide precursor solution to form a coating film on the core.

Examples of the material for the core include metal (aluminum, stainless steel, etc.), and metal having a surface coated with a material having a releasing property, such as fluororesin or silicone resin.

When a metal core is used, the surface of the core may be plated with, for example, chromium or nickel, or pre-coated with a releasing agent so that the polyimide tubular member formed on the surface of the core can be easily removed from the core.

The core may have a cylindrical or columnar shape.

The method for coating the core with the polyimide precursor solution is not particularly limited. Examples of the method include an outer surface coating method described in Japanese Unexamined Patent Application Publication No. 6-23770, etc., a dip coating method described in Japanese Unexamined Patent Application Publication No. 3-180309 etc., and a spiral coating method (flow coating method) and a spin coating method described in Japanese Unexamined Patent Application Publication No. 9-85756 etc. The method is selected according to the shape and size of the core.

The method for coating a core with a pre-heated polyimide precursor solution will now be described by using the spiral coating method as an example.

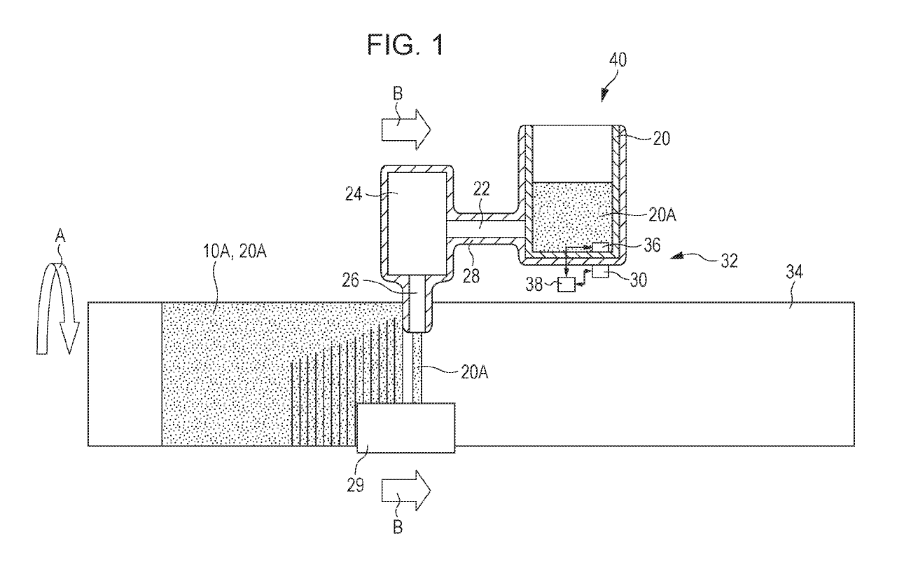

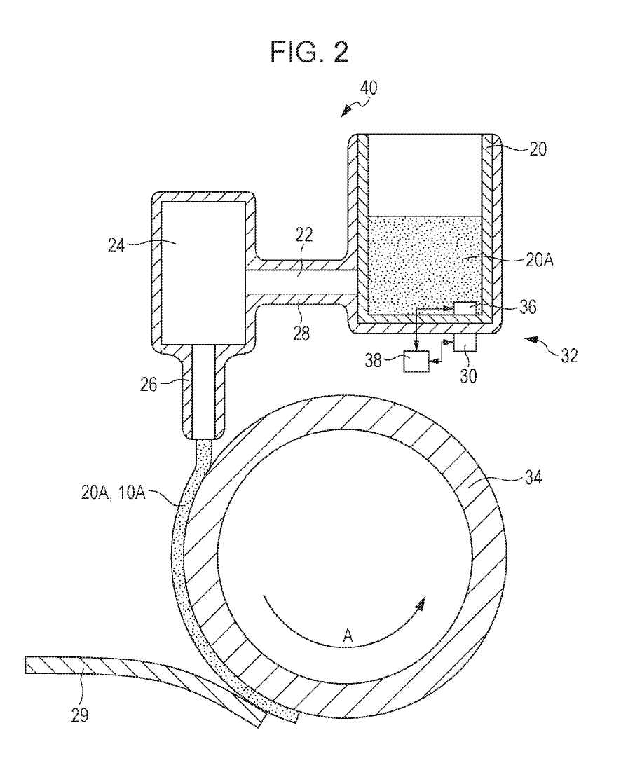

FIG. 1 is a schematic view of an exemplary structure of a coater that can be used to coat a core with a polyimide precursor solution by a spiral coating method in the method for producing a polyimide tubular member according to this exemplary embodiment. FIG. 2 is a schematic view showing a part of the coater in close-up.

A coater 40 illustrated in FIGS. 1 and 2 applies a polyimide precursor solution 20A to an outer surface (outer peripheral surface) of a cylindrical core 34 being rotated in a circumferential direction. At the same time, the applied polyimide precursor solution 20A is evened out by a blade (spatula) 29 arranged along the outer peripheral surface of the core 34.

The coater 40 uses a pump 24 so that the polyimide precursor solution 20A stored in a reservoir 20 is sent through a feed pipe 22 and a nozzle 26 and supplied to the outer peripheral surface of the core 34 rotating in the arrow A direction.

The polyimide precursor solution 20A applied to the outer peripheral surface of the core 34 has a line shape but is leveled by a blade 29. As a result, a coating film 10A is formed without a trace of the spiral line of the polyimide precursor solution 20A on the core 34.

The rotation rate of the core 34 during coating is, for example, 20 rpm or more and 300 rpm or less. The relative moving speed between the nozzle 26 and the core 34 is, for example, 0.1 m/min or more and 2.0 m/min or less.

The coater 40 and the core 34 are relatively moved toward one end to the other end of the core 34 in the longitudinal direction (arrow B direction in FIG. 1). As a result, a coating film 10A formed of the polyimide precursor solution 20A is formed on the core 34.

The coater 40 includes a temperature maintaining device 32 that maintains the temperature of the polyimide precursor solution 20A in the reservoir 20 and the temperature of the polyimide precursor solution 20A flowing in the feed pipe 22, the pump 24, and the nozzle 26 to designated temperatures. The temperature maintaining device 32 may have any configuration capable of maintaining the temperature of the polyimide precursor solution 20A in the reservoir 20 and the temperature of the polyimide precursor solution 20A flowing in the feed pipe 22, the pump 24, and the nozzle 26 to designated temperatures.

The temperature maintaining device 32 may be configured to include, for example, a temperature retaining member 28, a temperature adjusting unit 30, a thermometer 36, and a controller 38.

The temperature retaining member 28 is a member that has ability to keep heat, and covers outer walls of the reservoir 20, the feed pipe 22, the pump 24, and the nozzle 26.

The temperature adjusting unit 30 is a device that maintains the temperature on the inner side of the temperature retaining member 28 (that is, interiors of the reservoir 20, the feed pipe 22, the pump 24, and the nozzle 26) to a designated temperature. The temperature adjusting unit 30 may be any known device capable of adjusting the temperature (heating or cooling). The temperature adjusting unit 30 heats or cool the inner side of the temperature retaining member 28 so that the temperature of the polyimide precursor solution 20A inside the reservoir 20, the feed pipe 22, the pump 24, and the nozzle 26 in the temperature retaining member 28 is retained to a designated temperature.

The thermometer 36 is located in the reservoir 20 (for example, at the bottom of the interior of the reservoir 20) and measures the temperature of the polyimide precursor solution 20A stored in the reservoir 20.

The controller 38 is electrically coupled to the thermometer 36 and the temperature adjusting unit 30 and controls the temperature adjusting unit 30 on the basis of the temperature data received from the thermometer 36 so that the temperature on the inner side of the temperature retaining member 28 is maintained to a designated temperature.

### Drying Step

After coating, the drying step of drying the coating film 10A formed on the core 34 is performed. In the drying step, the coating film 10A is heated to evaporate the solvent contained in the polyimide precursor solution contained in the coating film 10A.

Drying is performed by adjusting the temperature, time, and other factors according to the types of the polyimide resin precursor and solvents. The coating film 10A may crack if the solvent content in the coating film decreases due to evaporation of the solvent from the coating film 10A. Accordingly, in the drying step, a particular amount (for example, about 5% by mass or more and about 40% by mass or less of the initial amount) of solvent may be left unevaporated.

The higher the drying temperature, the shorter the drying time. For example, drying may be performed at about 100° C. or higher and 200° C. or lower for 20 to 60 minutes. During drying, hot air may be applied. The temperature may be increased stepwise or at a constant rate.

In drying, the core 34 may be kept at a position such that its axis lies in the horizontal direction and may be rotated at a rate of 5 rpm or more and 60 rpm or less in order to reduce thickness nonuniformity caused by sagging of the coating solution constituting the undried coating film 10A in one direction of the core.

### Baking Step

Next, in the baking step, the dried coating film is baked to conduct imidization. In the baking step, the core 34 may be kept at a position such that its axis lies in the vertical direction.

The coating film 10A dried in the drying step is heated at a temperature higher than the heating temperature employed in the drying step so as to imidize the polyimide resin precursor contained in the coating film 10A. As a result, a polyimide-resin-containing tubular member (polyimide tubular member) 10 is obtained.

Imidization in the baking step occurs by performing heating at 250° C. or higher and 450° C. or lower or 300° C. or higher and 400° C. or lower, for example. As a result, the polyimide resin precursor is cured (imidized) and forms a polyimide resin. In the baking step, the heating temperature may be increased stepwise or at a constant rate. In the baking step, hot air or an infrared energy may be applied during heating.

The heating time in the baking step is, for example, 30 minutes or more and 180 minutes or less. There is a tendency in the baking step that the heating time can be shortened by increasing the heating temperature. In this exemplary embodiment, since a part of the polyimide precursor is already imidized by heating prior to coating, the heating time in the baking step is shortened.

As a result of baking, a tubular layer containing a polyimide resin (polyimide tubular member) is formed on the outer peripheral surface of the core 34.

After baking, the tubular member is separated from the core 34, and two end portions are cut to adjust the width to a desired width to obtain a desired polyimide tubular member.

The thickness of the polyimide tubular member produced through the above-mentioned steps may be set according to the usage. For example, the thickness is in the range of 30 μm or more and 150 μm or less if the polyimide tubular member is to be used as an intermediate transfer belt of an image forming apparatus.

If a thick polyimide tubular member is to be formed, for example, the coating step and the drying step are alternately repeated two or more times and then the baking step is performed. As a result, a thick polyimide tubular member is obtained.

The usage of the polyimide tubular member produced by the exemplary embodiment is not particularly limited. Examples of the usage include intermediate transfer belts, sheet conveying belts, fixing belts, etc., of electrophotographic image forming apparatuses such as copiers and printers.

### EXAMPLES

Examples are described below. These examples are not limiting.

### Example 1

### Preparation Step and Heating Step

To a N-methyl-2-pyrrolidone (NMP) solution (solid content: 18% by mass) of polyamic acid (polyimide precursor) obtained by polymerization of 3,3′,4,4′-biphenyltetracarboxylic dianhydride and 4,4′-diaminodiphenyl ether, 80 parts by mass of resin-coated carbon black (Color Black FW1: Orion Engineered Carbons) is added relative to 100 parts by mass of the solid component in the polyamic acid. The resulting mixture is passed through a dispersing unit of a jet mill disperser (Geanus PY produced by Geanus Co.) four times at a pressure of 200 MPa to conduct dispersing and mixing. As a result, a dispersion is obtained.

To the obtained dispersion, an NMP solution (solid content after imidization conversion: 18% by mass) of polyamic acid (polyimide precursor) prepared by polymerizing 3,3′,4,4′-biphenyltetracarboxylic dianhydride and 4,4′-diaminodiphenyl ether is added so that the amount of carbon black is 24 parts by mass relative to 100 parts by mass of the polyamic acid.

The resulting mixture is mixed and stirred by using a planetary mixer (Aicoh Mixer produced by Aicohsha Manufacturing Co., Ltd.) while being heated to 50° C. As a result, a carbon black-dispersed polyimide precursor solution (hereinafter referred to as “polyimide precursor solution”) is obtained.

The obtained polyimide precursor solution is analyzed by the aforementioned method to determine the imidization degree. The imidization degree is 8.2%.

### Coating Step

A mold having an inner diameter of 272 mm, an outer diameter of 278 mm, and a body length of 800 mm is used as the core. The outer peripheral surface of the body of the core is preliminarily coated with a coating solution prepared by diluting a silicone releasing agent (Sepacoat produced by Shin-Etsu Chemical Co., Ltd.) with n-heptane at a diluting ratio of 1:15, and baked at 420° C. for 40 minutes.

Next, the core is placed so that its axial direction is horizontal and its two ends are in contact with a driving roll. While the core is being rotated at 53.4 rpm, the polyimide precursor solution is allowed to fall onto the outer peripheral surface of the rotating core, and, at the same time, the polyimide precursor solution applied to the outer peripheral surface of the core is leveled with a spatula. The point at which the polyimide precursor solution is allowed to fall (point of fall) and the spatula are moved in a horizontal direction from one end of the core to the other end of the core (in core axial direction) to form a coating film on the outer peripheral surface of the core. The amount of the polyimide precursor solution allowed to fall is set to 95 g/60 seconds, the moving speed of the point of fall and the spatula in the horizontal direction is set to 245.6 mm/min, and the width of the region of the core in which the coating film is formed (width in the axial direction) is set to 770 mm.

### Drying Step

The core having the coating film on the outer peripheral surface is placed in a drying furnace so that its axial direction is coincident with the horizontal direction and its two ends are in contact with the driving roll. The core with the coating film is then dried at 187° C. for 26 minutes by being rotated at 20 rpm.

### Baking Step

The core is placed in a heating furnace so that the axial direction of the core is coincident with the vertical direction, and baked. Baking is conducted by gradually elevating the temperature from near room temperature so that the temperature of the heating furnace reaches 315° C. after 2 hours, and then keeping 315° C. for 40 minutes.

### Example 2

A dispersion is obtained as in Example 1.

To the obtained dispersion, an NMP solution (solid content after imidization conversion: 18% by mass) of polyamic acid prepared from 3,3′,4,4′-biphenyltetracarboxylic dianhydride and 4,4′-diaminodiphenyl ether is added so that the amount of carbon black is 24 parts by mass relative to 100 parts by mass of the polyamic acid. The resulting mixture is mixed and stirred by using a planetary mixer (Aicoh Mixer produced by Aicohsha Manufacturing Co., Ltd.) while being heated to 80° C. As a result, a carbon black-dispersed polyimide precursor solution is obtained.

The obtained polyimide precursor solution is analyzed by the aforementioned method to determine the imidization degree. The imidization degree is 9.5%.

Then the same subsequent steps are performed as in Example 1 to obtain a polyimide tubular member.

### Example 3

A dispersion is obtained as in Example 1.

To the obtained dispersion, an NMP solution (solid content after imidization conversion: 18% by mass) of polyamic acid prepared from 3,3′,4,4′-biphenyltetracarboxylic dianhydride and 4,4′-diaminodiphenyl ether is added so that the amount of carbon black is 24 parts by mass relative to 100 parts by mass of the polyamic acid. The resulting mixture is mixed and stirred by using a planetary mixer (Aicoh Mixer produced by Aicohsha Manufacturing Co., Ltd.) while being heated to 100° C. As a result, a carbon black-dispersed polyimide precursor solution is obtained.

The obtained polyimide precursor solution is analyzed by the aforementioned method to determine the imidization degree. The imidization degree is 12.5%.

Then the same subsequent steps are performed as in Example 1 to obtain a polyimide tubular member.

### Example 4

A dispersion is obtained as in Example 1.

To the obtained dispersion, an NMP solution (solid content after imidization conversion: 18% by mass) of polyamic acid prepared from 3,3′,4,4′-biphenyltetracarboxylic dianhydride and 4,4′-diaminodiphenyl ether is added so that the amount of carbon black is 24 parts by mass relative to 100 parts by mass of the polyamic acid. The resulting mixture is mixed and stirred by using a planetary mixer (Aicoh Mixer produced by Aicohsha Manufacturing Co., Ltd.) while being heated to 150° C. As a result, a carbon black-dispersed polyimide precursor solution is obtained.

The obtained polyimide precursor solution is analyzed by the aforementioned method to determine the imidization degree. The imidization degree is 15.2%.

Then the same subsequent steps are performed as in Example 1 to obtain a polyimide tubular member.

### Example 5

A dispersion is obtained as in Example 1.

To the obtained dispersion, an NMP solution (solid content after imidization conversion: 18% by mass) of polyamic acid prepared from 3,3′,4,4′-biphenyltetracarboxylic dianhydride and 4,4′-diaminodiphenyl ether is added so that the amount of carbon black is 24 parts by mass relative to 100 parts by mass of the polyamic acid. The resulting mixture is mixed and stirred by using a planetary mixer (Aicoh Mixer produced by Aicohsha Manufacturing Co., Ltd.) while being heated to 40° C. As a result, a carbon black-dispersed polyimide precursor solution is obtained.

The obtained polyimide precursor solution is analyzed by the aforementioned method to determine the imidization degree. The imidization degree is 7.9%.

Then the same subsequent steps are performed as in Example 1 to obtain a polyimide tubular member.

### Comparative Example 1

A dispersion is obtained as in Example 1.

To the obtained dispersion, an NMP solution (solid content after imidization conversion: 18% by mass) of polyamic acid prepared from 3,3′,4,4′-biphenyltetracarboxylic dianhydride and 4,4′-diaminodiphenyl ether is added so that the amount of carbon black is 24 parts by mass relative to 100 parts by mass of the polyamic acid. The resulting mixture is mixed and stirred by using a planetary mixer (Aicoh Mixer produced by Aicohsha Manufacturing Co., Ltd.) at room temperature (23° C.). As a result, a carbon black-dispersed polyimide precursor solution is obtained.

The obtained polyimide precursor solution is analyzed by the aforementioned method to determine the imidization degree. The imidization degree is 1.5%.

Then the same subsequent steps are performed as in Example 1 to obtain a polyimide tubular member.

The heating temperature before coating, the coating length in the core axial direction and the length after baking, and the shrinkage are shown in Table. The shrinkage (%) is calculated by the following formula based on the length in the axial direction before drying (coating length: average of 4 points in the circumferential direction) and the length in the axial direction after baking (length after baking: average of 4 points in the circumferential direction):

Shrinkage (%)=[(coating length−length after baking)/coating length]×100

TABLE

| | | Imidiza- | | | |
|---|---|---|---|---|---|
| | Heating | tion | | | |
| | temperature | degree | | Length | |
| | before | before | Coating | after | |
| | coating | coating | length | baking | Shrinkage |
| Example 1 | 50° C. | 8.2% | 770 mm | 763 mm | 0.91% |
| Example 2 | 80° C. | 9.5% | 770 mm | 765 mm | 0.65% |
| Example 3 | 100° C. | 12.5% | 770 mm | 765.5 mm | 0.58% |
| Example 4 | 150° C. | 15.2% | 770 mm | 767 mm | 0.39% |
| Example 5 | 40° C. | 7.9% | 770 mm | 762 mm | 1.04% |
| Comparative | 23° C. (room | 1.5% | 770 mm | 760 mm | 0.30% |
| Example 1 | temperature) | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for producing a polyimide tubular member, comprising:
preparing a polyimide precursor solution;
heating the polyimide precursor solution;
coating a core with the heated polyimide precursor solution to form a coating film;
drying the coating film; and
baking the dried coating film to perform imidization.

2. The method according to claim 1, wherein, in heating the polyimide precursor solution, the polyimide precursor solution is heated to a temperature of about 50° C. or higher and about 150° C. or lower.
